(19) United States
(12) Patent Application Publication
(10) Pub. No.: US 2026/0364589 A1
(43) Pub. Date: Nov. 19, 2026

(54) PIPETTE CONTROLLER

(71) Applicant: Vistalab Technologies, LLC, Patterson, NY (US)

(72) Inventors: Jon Peter Benack, Mahopac, NY (US); Yevgeniy Andreyevich Kozlenko, New Fairfield, CT (US); Devon Daniel Brown, Bedford Hills, NY (US)

(21) Appl. No.: 19/675,273

(22) Filed: May 12, 2026

Related U.S. Application Data
(60) Provisional application No. 63/805,183, filed on May 13, 2025.

(51) Int. Cl. B01L 3/02

(52) U.S. Cl. CPC B01L 3/0213; B01L 2200/02; B01L 2200/087; B01L 2200/146; B01L 2300/023; B01L 2400/0487; B01L 2400/06

(57) ABSTRACT

A pipette controller includes a nozzle assembly configured to operatively connect a pipette to the pipette controller, a pressure tank pneumatically connected to the nozzle assembly, a pump pneumatically connected to the nozzle assembly and to the pressure tank, an aliquot valve, an aspiration valve, and an electronic controller in electrical communication with the pump, the aliquot valve, and the aspiration valve. The electronic controller is configured, in response to receiving an aspiration command signal, to operate the pipette controller in an aspiration mode by operating the pump to draw in air from the nozzle assembly, and, in response to receiving an aliquot command signal, to operate the pipette controller in an aliquot mode by transferring an amount of air from the pressure tank to the nozzle assembly to dispense a volume of fluid from the pipette equal to an aliquot volume.

### CROSS REFERENCE TO RELATED APPLICATIONS

This application claims the benefit of priority of U.S. Provisional Patent Application No. 63/805,183, filed on May 13, 2025, the contents of which is hereby incorporated by reference in its entirety.

### TECHNICAL FIELD

The present disclosure relates generally to pipette controllers.

### BACKGROUND

Pipette controllers generally provide for aspirating liquid into a pipette and dispensing of aliquots of liquid from the pipette. Pipette controllers are commonly utilized in laboratory settings for liquid measurement and dispensing to perform various scientific tasks, such as drug development, environmental testing, and diagnostic testing.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1 is an elevational view of an exemplary pipette controller, according to the present disclosure.

FIG. 2 is a cutaway view of the pipette controller of FIG. 1.

FIG. 3 is a schematic diagram of components of the pipette controller of FIG. 1.

FIGS. 4A and 4B are flowcharts depicting an exemplary aliquot mode of the pipette controller of FIGS. 1 to 3.

FIG. 5 is a schematic diagram of serological pipette pressures.

FIG. 6 is a schematic diagram of a serological pipette disposed vertically and disposed at an angle.

FIG. 7 is a flowchart showing an exemplary method of aspirating and dispensing a fluid from a pipette using a pipette controller, such as the pipette controller of FIG. 1, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

Although the term “pipette” and “pipette controller” may be used to describe embodiments of the present disclosure, a person skilled in the relevant art will recognize that other devices that aspirate fluids may be used without departing from the spirit and scope of the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for a pipette controller for aspirating aliquots of fluid into a pipette and precisely dispensing multiple aliquots of the liquid from the pipette. The fluid in the pipette may alternatively be manually dispensed by the pipette controller. An aliquot volume to be automatically dispensed by the pipette controller can be varied by a user.

Serological pipettes are widely used for liquid measurement and dispensing in laboratories. Depending on a particular application, such pipettes may be formed of various materials, e.g., glass or plastic, and may be provided in various sizes, e.g., one (1) milliliter (ml) to one hundred (100) ml, with graduations printed on them. Traditionally, liquid was drawn into such pipettes by applying suction to the top end thereof by a rubber bulb, measured by aspirating to a graduation line, and then dispensed by removing the suction. Current practice often utilizes a pipette controller, which uses a small, battery-powered air pump and trigger-style pneumatic valves to manipulate pressure inside of serological pipettes to draw up and then to expel liquid therefrom.

Frequently, multiple aliquots of a liquid sample must be dispensed for analytical processes. To do this, a user first aspirates slightly more than the required volume and then slowly dispenses the sample until the meniscus of the fluid aligns with a graduation line on the serological pipette to achieve a starting volume. The user must note the starting volume and then dispense fluid until the meniscus drops to the graduation line corresponding to the difference between the starting volume and the desired dispense volume. If another aliquot is required, the user dispenses again to the graduation line corresponding to the difference between the prior reading and the desired volume. However, this methodology is a time consuming and fatiguing process, especially when this process must be repeated many times. In addition, this process introduces multiple sources of error.

Some conventional pipette controllers utilize a vacuum tank and a pressure tank to overcome some of the described above issues and to provide a more user friendly and accurate pipette controller. However, such conventional pipette controllers commonly require a substantial amount of tubing extending between the tanks and other components of the pipette controller. As such, these conventional pipette controllers may have a size and weight that make the pipette controller too large to conveniently be carried and used in a laboratory setting.

Accordingly, the present disclosure provides for a pipette controller that can provide for accurate dispensing of aliquots of liquid via a single dispense actuator. Thus, embodiments of the present disclosure can provide a pipette controller that accurately dispenses aliquots of liquid, but with a significantly less complex system structure, thus, providing a reduced overall size and weight, as compared to conventional pipette controllers.

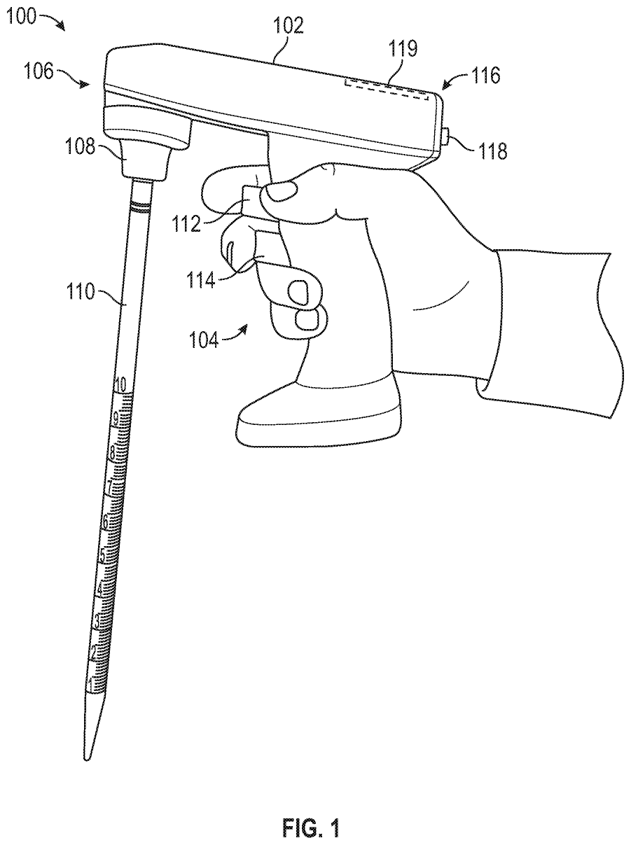

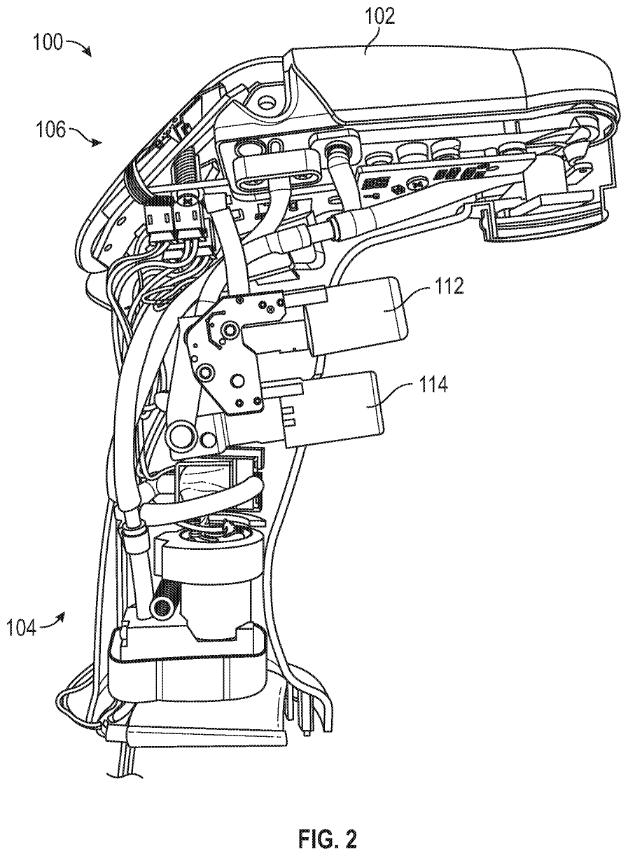

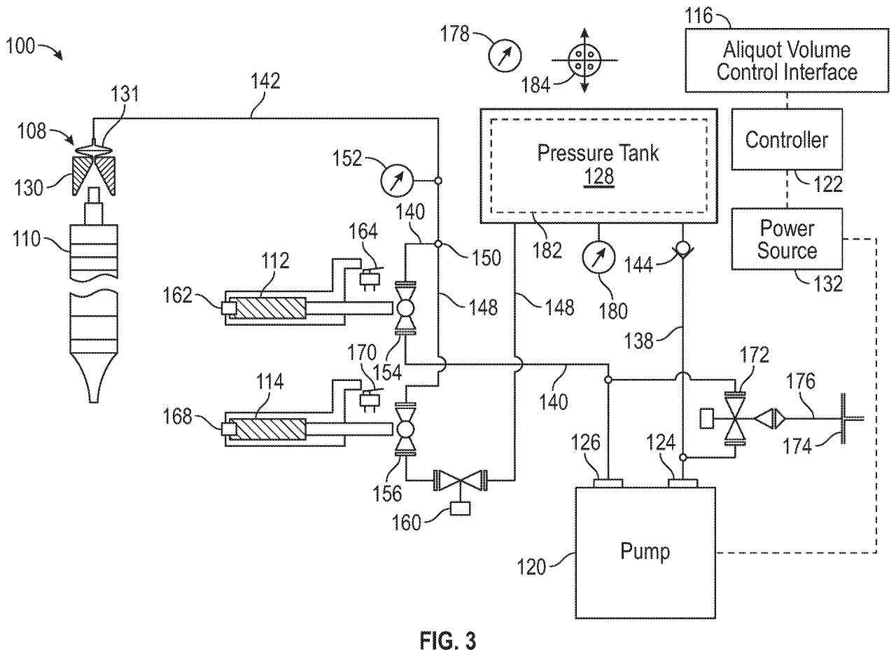

Referring now to the drawings, FIGS. 1 and 2 illustrate an exemplary pipette controller 100, according to an embodiment of the present disclosure. The pipette controller 100 includes a housing 102 with a lower housing portion 104 and an upper housing portion 106 extending from the lower housing portion 104. As shown in FIG. 1, the lower housing portion 104 is configured to be grasped in a palm of a hand of a user in order to operate the pipette controller 100. A nozzle assembly 108 extends from a distal end of the upper housing portion 106 and is configured to removably receive a serological pipette 110. As will be discussed in greater detail below with reference to FIG. 3, when the pipette 110 is received by the nozzle assembly 108, the pipette 110 is pneumatically connected to the pipette controller 100 via a cone seal 130 (FIG. 3) of the nozzle assembly 108. The pipette 110 may be removed from nozzle assembly 108 by engaging a portion of the nozzle assembly 108, such as a cover that engages the cone seal 130 (FIG. 3). As such, a user of the pipette controller 100 may quickly remove and replace the pipette 110, via the nozzle assembly 108, with another pipette having one or more different characteristics.

An aspiration actuator 112 and a dispense actuator 114 extend from the lower housing portion 104 and are configured to be engageable by one or more fingers of the user during operation of the pipette controller 100. As will be discussed in greater detail below with reference to FIG. 3, the pipette controller 100 may aspirate a volume of a fluid into the pipette 110 when the user depresses aspiration actuator 112 and may dispense fluid from the pipette 110 when the user depresses dispense actuator 114. Although the aspiration actuator 112 and the dispense actuator 114 are depicted as buttons in the illustrated embodiment of FIG. 1, the aspiration actuator 112 and the dispense actuator 114 may be any type of user interface that can be engageable by a user.

Referring still to FIG. 1, the pipette controller 100 further includes an aliquot volume control interface 116 disposed toward a proximal end of the upper housing portion 106 of the housing 102. As will be discussed in greater detail below with reference to FIG. 3, the aliquot volume control interface 116 is operable by the user to select a set aliquot volume that is dispensed from the pipette when the pipette controller is operating in an aliquot mode (as opposed to a dispense mode). In some embodiments, the aliquot volume control interface 116 may be operable by the user to switch between the aliquot mode and the dispense mode. In the illustrated embodiment, the aliquot volume control interface 116 includes one or more aliquot control buttons 118 operable by a user to adjust a set aliquot volume of the pipette controller 100 and a display screen 119 (e.g., a liquid-crystal display (LCD), an electronic paper (E-ink) display, among others) to display one or more operational parameters of the pipette controller 100. For example, in some embodiments, the display screen 119 may display the set aliquot volume, a currently selected operating mode (e.g., a dispense mode or an aliquot mode), a battery percentage of a power source (e.g., power source 132 of FIG. 3), among others.

In some embodiments, the one or more aliquot control buttons 118 of the aliquot volume control interface 116 may be touch capacitive sensors configured to receive a user input via contact with a user's finger. In some embodiments, the aliquot volume control interface 116 can include a dial or a keypad. In some embodiments, the pipette controller 100 may be configured to connect to a user's mobile device (e.g., a mobile phone, a smartwatch, etc.) and the aliquot volume control interface 116 can be provided on the user's mobile device. In some embodiments, the pipette controller 100 may further include one or more visual, audio, or haptic indicators that are configured to indicate one or more operational parameters to the user. For example, in some embodiments, a vibrational indicator may be disposed within the lower housing portion 104 of the housing 102 that may cause vibrations to the user's hand to indicate to the user that the pipette controller 100 is ready for a subsequent aliquot dispense.

Referring now to FIG. 3, the pipette controller 100 further includes a pump 120 and an electronic controller 122 that is powered by a power source 132. The electronic controller 122 is in electrical communication with the aliquot volume control interface 116 and the pump 120 such that the aliquot volume control interface 116 and the pump 120 are powered by the power source 132. In some embodiments, the power source 132 can be a battery that is rechargeable or replaceable within the housing 102. In some embodiments, the power source 132 can be a power input that is configured to connect to a power source external to the pipette controller 100.

The pump 120 has a pump outlet 124 that is pneumatically connected to a pressure tank 128 via a pump conduit 138 and a pump inlet 126 that is pneumatically connected to the nozzle assembly 108 via an aspiration conduit 140 extending from the pump inlet 126 to a pipette conduit 142, which extends from the nozzle assembly 108. As will be discussed in greater detail below, the pump 120 is configured to draw in air from the nozzle assembly 108 (i.e., and from the pipette 110 coupled to the cone seal 130 thereto) along the aspiration conduit 140 to aspirate a volume of fluid into the pipette 110 (e.g., with the pipette controller 100 operating in an aspiration mode) and to inject air along the pump conduit 138 into the pressure tank 128 to create positive air pressure inside the pressure tank 128 that is used to dispense an aliquot volume from the pipette 110 (e.g., with the pipette controller 100 operating in an aliquot mode). A check valve 144 may be disposed along the pump conduit 138 to prevent pressurized air from leaking out of the pressure tank 128 to the pump conduit 138 when the pump 120 is not operated.

With continued reference to FIG. 3, the pressure tank 128 is also pneumatically connected to the nozzle assembly 108 (via the pipette conduit 142) by a dispense conduit 148 extending from the pressure tank 128 to the pipette conduit 142. Thus, in the illustrated embodiment, the pipette conduit 142 is pneumatically connected to both the aspiration conduit 140 and the dispense conduit 148 at a junction 150. Particularly, the pipette conduit 142 is pneumatically connected to the junction 150 at one end and to the cone seal 130 of the nozzle assembly 108 at the other end. As shown in FIG. 3, the nozzle assembly 108 can further include an air filter 131 arranged between the pipette conduit 142 and the cone seal 130 that can reduce or prevent debris from entering the pipette conduit 142 or from entering the pipette 110. In some embodiments, a manifold may be arranged at junction 150 that may be configured to direct flow between the pipette conduit 142, the aspiration conduit 140, and the dispense conduit 148.

As shown in the illustrated embodiment, a pipette pressure sensor 152 is arranged at the junction 150 to sense an air pressure within the pipette conduit 142 (and thus also within the pipette 110 attached to the nozzle assembly 108). The pipette pressure sensor 152 is in electrical communication with the electronic controller 122, which is configured to receive signals from the pipette pressure sensor 152. In some embodiments, the pipette pressure sensor 152 can be arranged along the pipette conduit 142 between the nozzle assembly 108 and the junction 150. In some embodiments, the pipette pressure sensor 152 can be part of the nozzle assembly 108.

Referring still to FIG. 3, an aspiration valve 154 is arranged along the aspiration conduit 140 between the pump inlet 126 and the junction 150. The aspiration valve 154 is operably coupled to the aspiration actuator 112. In this way, the aspiration actuator 112 is operable by the user to move the aspiration valve 154 from a closed position, in which the aspiration valve 154 prevents airflow along the aspiration conduit 140, toward an open position, in which the aspiration valve 154 permits airflow along the aspiration conduit 140. Similarly, a dispense valve 156 is arranged along the dispense conduit between the pressure tank 128 and the junction 150. The dispense valve 156 is operably coupled to the dispense actuator 114. In this way, the dispense actuator 114 is operable by the user to move the dispense valve 156 from a closed position, in which the dispense actuator 114 prevents airflow along the dispense conduit 148, toward an open position, in which the dispense actuator 114 permits airflow along the dispense conduit 148. In the illustrated embodiment, the aspiration valve 154 and the dispense valve 156 are normally closed ball valves.

An aspiration switch 164 and a dispense switch 170 are in electrical communication with the electronic controller 122 and are arranged to detect movement of the aspiration actuator 112 and the dispense actuator 114, respectively. Particularly, while the pipette controller 100 is operated in the aspiration mode, the aspiration switch 164 provides an aspiration command signal to the electronic controller 122 when the aspiration actuator 112 is actuated (e.g., moved by the user to move the aspiration valve 154 from the closed position). Likewise, while the pipette controller 100 is operated in the dispense mode, the dispense switch 170 provides a dispense command signal to the electronic controller 122 when the dispense actuator 114 is actuated (e.g., e.g., moved by the user to move the dispense valve 156 from the closed position). Further, while the pipette controller 100 is operated in the aliquot mode, the dispense switch 170 can also provide an aliquot command signal to the electronic controller 122 when the dispense actuator 114 is actuated.

In some embodiments, the aspiration actuator 112 can further include an aspiration interface 162 that is movable from a disengaged position, in which the aspiration valve 154 is in the closed position, and an engaged position, in which the aspiration valve 154 is in the fully open position. In some such embodiments, the aspiration interface 162 can biased toward the disengaged position, and the aspiration switch 164 can be arranged to detect movement of the aspiration interface 162 from the disengaged position (i.e., an aspiration trigger event) and to provide the aspiration command signal to the electronic controller 122. In some embodiments, the dispense actuator 114 can further include a dispense interface 168 that is movable from a disengaged position, in which the dispense valve 156 is in the closed position, and an engaged position, in which the dispense valve 156 is in the fully open position. In some such embodiments, the dispense interface 168 can biased toward the disengaged position, and the dispense switch 170 can be arranged to detect movement of the dispense interface 168 from the disengaged position (e.g., a dispense trigger event) and to provide the dispense command signal or the aliquot command signal to the electronic controller 122. In some embodiments, one or both of the aspiration interface 162 or the dispense interface 168 can be a button that is depressible by the user.

With continued reference to FIG. 3, an aliquot valve 160 is arranged along the dispense conduit 148 between the pressure tank 128 and the dispense valve 156. In other words, the aliquot valve 160 is located upstream from the dispense valve 156 relative to airflow along the dispense conduit 148 as pressurized air provided from the pressure tank 128 flows to the pipette conduit 142. In the illustrated embodiment, the aliquot valve 160 is a normally open solenoid actuated ball valve that is in electrical communication with the electronic controller 122. In this way, the electronic controller 122 is configured to move the aliquot valve 160 from an open position, in which the aliquot valve 160 permits airflow along the dispense conduit 148, to a closed position, in which the aliquot valve prevents airflow along the dispense conduit 148. In other embodiments, the aliquot valve 160 can be any other type of two-way valve.

A pump valve 172 is pneumatically connected to the pump conduit 138 and the aspiration conduit 140, and to an air vent 174 via a vent conduit 176. The air vent 174 is in fluid communication with atmospheric air external to the pipette controller 100. In the illustrated embodiment, the pump valve 172 is a three-way solenoid actuated valve in electrical communication with the electronic controller 122. In this way, the electronic controller 122 is configured to selectively move the pump valve 172 between a first position, in which airflow is permitted between the aspiration conduit 140 and the air vent 174, and a second position, in which airflow is permitted between the pump conduit 138 and the air vent 174. An atmospheric pressure sensor 178 is in electrical communication with the electronic controller 122 and arranged within the housing 102 (FIG. 1) to sense an atmospheric pressure external to the pipette controller 100.

In some embodiments, the pump conduit 138, the aspiration conduit 140, the pipette conduit 142, the dispense conduit 148, and the vent conduit 176 may be tubing (e.g., plastic tubing) that pneumatically connects the respective components of the pipette controller 100. Thus, an overall length of tubing of the pipette controller 100 may be reduced due to the particular configuration of the pipette controller 100, as compared to pipette controllers without the benefit of the present disclosure.

The pipette controller 100 is configured to operate in an aspiration mode, in which the user manually aspirates fluid into the pipette 110 via the aspiration actuator 112, and a dispense mode, in which the user manually dispenses fluid from the pipette 110 via the dispense actuator 114. The aspiration mode is initiated by actuation of the aspiration actuator 112 (or engagement of the aspiration interface 162) by the user, which causes the aspiration switch 164 to provide the aspiration command signal to the electronic controller 122. In response to receiving the aspiration command signal from the aspiration switch 164, the electronic controller 122 moves the pump valve 172 from the first position to the second position, which permits airflow between the pump conduit 138 and the air vent 174. The electronic controller 122 then operates the pump 120, which, being in communication with the air vent 174 via the pump valve 172, causes the pump 120 to draw in air from the nozzle assembly 108 along the pipette conduit 142 to the aspiration conduit 140. Once the aspiration actuator 112 is disengaged, the electronic controller 122 ceases operation of the pump 120 and moves the pump valve 172 from the second position back to the first position (or to a third position (e.g., that prevents airflow between the pump conduit 138 and each of the aspiration conduit 140 and the air vent 174)).

From the aspiration mode, the dispense mode is initiated by actuation of the dispense actuator 114 (or engagement of the dispense interface 168) by the user, which causes the dispense switch 170 to provide the dispense command signal to the electronic controller 122. In response to receiving the dispense command signal from the dispense switch 170, the electronic controller 122 leaves the pump valve 172 in the first position, which permits airflow from the air vent 174 to the pump conduit 138, and operates the pump 120 to inject air (e.g., atmospheric air from the air vent 174) into the pressure tank 128 to maintain air flow through the pressure tank 128 to the aliquot valve 160 and then through the dispense valve 156 to the nozzle assembly 108. Thus, a dispense of fluid is released from the pipette 110 as the dispense valve 156 is moved from the closed position toward the open position (e.g., via actuation of the dispense actuator 114 by the user). In other words, a volume of a dispense of fluid released from the pipette 110 as the pipette controller 100 is operating in the dispense mode is controllable by the user via the dispense actuator 114.

In some embodiments, while operating in the dispense mode, a dispense speed of a dispense by the pipette controller 100 can be varied by the user. For example, in some such embodiments, the dispense actuator 114 can be configured such that the dispense valve 156 is movable, via the dispense actuator 114, to one of a plurality of partially open positions between the closed position and the fully open position to vary flow of the positive air pressure through the dispense valve 156. In other embodiments, a dispense speed of a dispense by the pipette controller 100 can be selectable by the user (e.g., via the aliquot volume control interface 116).

While operating in the dispense mode, the tank pressure within the pressure tank 128 will decrease from the predetermined target tank pressure after one or more dispenses are released from the pipette 110. Accordingly, in some embodiments, the electronic controller 122 can be configured to reinject air into the pressure tank 128, via the pump 120, to the predetermined target tank pressure after each aliquot volume dispensed.

In addition to the dispense mode described above, the pipette controller 100 can also be operated, via the electronic controller 122, in the aliquot mode. In the aliquot mode, a precise aliquot of fluid is dispensed from the pipette 110 in response to an initial engagement of the dispense actuator 114 and again with each subsequent engagement of the dispense actuator 114. For example, twenty (20) ml of fluid may first be aspirated into the pipette 110 by operation of the pipette controller 100 in the aspiration mode. An aliquot volume is selectable by the user (i.e., a set aliquot volume) via the aliquot volume control interface 116. Then, upon each engagement of the dispense actuator 114, the set aliquot volume is dispensed. In this example, if the set aliquot volume is two (2) ml, ten distinct aliquots of fluid can be dispensed from the single aspiration of the pipette 110.

To initiate the aliquot mode of the pipette controller 100, a user may select the aliquot mode from the aspiration mode or the dispense mode (e.g., via the aliquot volume control interface 116). In some embodiments, the user may also select the aliquot volume (i.e., the set aliquot volume) via the aliquot volume control interface 116. Prior to the aliquot mode, the pipette 110 may be aspirated (e.g., via the aspiration mode) with a volume greater than the set aliquot volume by engaging aspiration actuator 112 until the desired starting volume is aspirated into the pipette 110.

With the pipette controller 100 in the aliquot mode, to dispense a first aliquot, the dispense actuator 114 is engaged and an aliquot of fluid with a volume corresponding to the set aliquot volume is dispensed. Particularly, in response to receiving the aliquot command signal from the dispense switch 170, the electronic controller 122 leaves the pump valve 172 in the first position, which permits airflow from the air vent 174 to the pump conduit 138, and operates the pump 120 to inject air (e.g., atmospheric air from the air vent 174) along the pump conduit 138 to pressurize the pressure tank 128 to a predetermined target tank pressure. Once the predetermined target tank pressure is achieved within the pressure tank 128 (e.g., as sensed by a pressure tank sensor 180 in electrical communication with the electronic controller 122), the electronic controller 122 releases the aliquot valve 160 from the closed position to the normally open position, which permits positive air pressure from the pressure tank 128 to the nozzle assembly 108 and thus dispensing an aliquot volume of fluid contained within the pipette 110. More specifically, in the illustrated embodiment, positive air pressure from the pressure tank 128 flows through the aliquot valve 160 and then through the dispense valve 156 to the nozzle assembly 108. One or more subsequent aliquots may be dispensed by engaging the dispense actuator 114 until all of the starting volume of the fluid is dispensed from the pipette 110. In other words, with the pipette controller 100 operating in the aliquot mode, the predetermined target tank pressure of the pressure tank 128 is used to dispense one or more aliquots such that the pump 120 is not operated.

In order to provide for increased accuracy of the dispensed aliquot, the aliquot valve 160 is opened before the dispense valve 156 is moved from the closed position toward the open position. Thus, in some embodiments, the dispense switch 170 can be configured to provide the dispense command signal to the electronic controller 122 once the dispense actuator 114 is initially actuated but before the dispense valve 156 is moved from the closed position toward the open position.

In some embodiments, while operating in the aliquot mode, a dispense speed of an aliquot volume by the pipette controller 100 can be varied by the user. For example, in some such embodiments, the dispense actuator 114 can be configured such that the dispense valve 156 is movable, via the dispense actuator 114, to one of a plurality of partially open positions between the closed position and the fully open position to vary flow of the positive air pressure through the dispense valve 156. In other embodiments, a dispense speed of the aliquot volume by the pipette controller 100 can be selectable via the aliquot volume control interface 116.

While operating in the aliquot mode, the electronic controller 122 can be configured to determine (e.g., based on signals received from the pressure tank sensor 180) when the tank air pressure reaches a predetermined tank air pressure corresponding to an amount of air transferred from the pressure tank 128 to the nozzle assembly 108 to dispense a volume of fluid equal to an aliquot volume. The electronic controller 122 can be further configured, when the tank air pressure reaches the predetermined tank air pressure and the dispense actuator 114 is disengaged, to move the aliquot valve 160 to the closed position and to operate the pump 120 to reinject air into the pressure tank 128 to a predetermined target tank air pressure corresponding to the aliquot volume.

In some embodiments, the electronic controller 122 can be further configured to determine (e.g., based on signals received from the pressure tank sensor 180) when the tank pressure within the pressure tank 128 reaches a predetermined tank pressure and to reinject air into the pressure tank 128, via the pump 120, to the predetermined target tank pressure after two or more aliquot volumes are dispensed. In some such embodiments, the predetermined target tank pressure can provide for three or more aliquot volumes to be dispensed before air is reinjected into the pressure tank 128, via the pump 120, to the predetermined target tank pressure.

In some embodiments, the electronic controller 122 may adjust the predetermined tank air pressure based on the size of the set aliquot valve selected by the user. In this way, a reinjection time of the pump 120 to repressurize the pressure tank 128 to the predetermined tank air pressure can be minimized. For example, in some embodiments, electronic controller 122 can be configured to use a first predetermined tank air pressure for a first set aliquot volume and a second predetermined tank air pressure, that differs from the first predetermined tank air pressure, for a second set aliquot volume, that differs from the first set aliquot volume.

Due to pressure drops within the pressure tank 128 after repeated aliquot dispensing, a temperature within the pressure tank 128 may decrease during an aliquot dispense. As such, in some embodiments, the pressure tank 128 can include a tank air temperature regulator 182 that can be configured to reduce a change in a temperature of the pressurized air within the pressure tank 128 during continued operation of the pipette controller 100 in the aliquot mode. For example, in some embodiments, the tank air temperature regulator 182 can be a fabric material (e.g., polyester) arranged within an internal cavity of the pressure tank 128. In some such embodiments, the fabric material can be arranged throughout an entirety of the internal cavity of the pressure tank 128. In some embodiments, the fabric material can be arranged in layers within the internal cavity of the pressure tank 128.

As discussed in more detail below, the pipette controller 100 can further include an orientation sensor 184 (e.g., a gyroscope) in electrical communication with the electronic controller 122. The orientation sensor 184 can be configured to sense an angle of the pipette 110 relative to a reference axis (e.g., an absolute vertical or horizontal axis). In some embodiments, the electronic controller 122 can be further configured to determine (e.g., based on signals received from the orientation sensor 184) an angle of the pipette 110 relative to the reference axis, and to adjust, based on the determined angle of the pipette 110, the amount of air transferred from the pressure tank 128 to the nozzle assembly 108 to dispense the volume of fluid equal to the set aliquot volume.

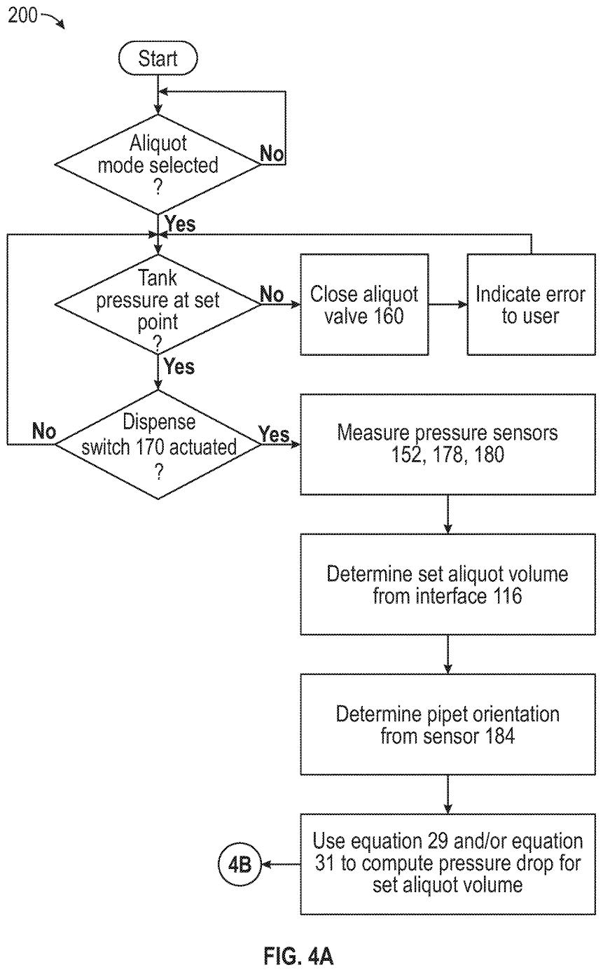

FIGS. 4A and 4B illustrate a flowchart 200 of an exemplary aliquot mode of the pipette controller 100. As shown in flowchart 200, with the aliquot mode of the pipette controller 100 selected, the tank pressure of the pressure tank 128 is determined via the pressure tank sensor 180. If the tank pressure of the pressure tank 128 is not at a set point (i.e., a predetermined tank pressure), the aliquot valve 160 is closed and an error is indicated to the user (e.g., via the aliquot volume control interface 116 (FIG. 1)). On the other hand, if the tank pressure of the pressure tank 128 is at the set point and the dispense switch 170 is actuated, the electronic controller 122 reads pressure sensors 152, 178, and 180, which provide the pressures in the pipette conduit 142, the pressure tank 128, and at the air vent 174, respectively. According to some embodiments, atmospheric pressure sensor 178 may be optional, and an atmospheric pressure may be determined by alternate means, such as a manual input. In some embodiments, all pressures measured by are absolute pressures, relative pressure to atmospheric pressure sensors may, however, also be used. Pressure sensors 152, 178, and 180 may also measure the temperature and provide corrections due to changes in temperature as well as pressure.

After the electronic controller 122 reads pressure sensors 152, 178, and 180, the electronic controller 122 determines a set aliquot volume (e.g., as set by the user via the aliquot volume control interface 116 (FIG. 1)) and further determines a pipette orientation (e.g., an angle of the pipette 110 relative to a reference axis) via the orientation sensor 184 (FIG. 3). The electronic controller 122 then computes a pressure drop for the set aliquot volume, as described in greater detail below with reference to equation (29) and equation (31) and determines the tank pressure of the pressure tank 128 again via the pressure tank sensor 180. Once the dispense valve 156 is opened (e.g., via actuation of the dispense actuator 114), air that is released from the pressure tank 128 is transmitted to the dispense conduit 148 and through aliquot valve 160 and dispense valve 156 to the pipette conduit 142. Thus, the tank pressure of the pressure tank 128 drops toward the value that corresponds to the set aliquot volume.

The electronic controller 122 closes the aliquot valve 160 once a change in the measured tank pressure (as sensed by pressure tank sensor 180) equals the calculated pressure change from equation (29) or equation (31) described below. If the dispense switch 170 continues to be actuated, the electronic controller 122 can indicate an error to the user (e.g., via the aliquot volume control interface 116 (FIG. 1)). With the dispense switch 170 no longer actuated, the electronic controller 122 operates the pump 120 and moves the pump valve 172 to the second position to re-pressurize the pressure tank 128. This process may be repeated for each subsequent aliquot. Other types of pressure vessels may be substituted for pressure tank 128.

Boyle's Law (i.e., PV=nRT) teaches that a container of known volume (V) at a known pressure (P) and temperature (T) will hold a known number of air molecules (n). If the pressure in this volume is reduced a known amount, then a known number of air molecules will be released. According to embodiments, this principle is used to inject a known number of air molecules into a serological pipette (e.g., pipette 110 of FIGS. 1 to 3). The relationship between the quantity of air to be injected into the serological pipette and the set aliquot volume is derived as follows.

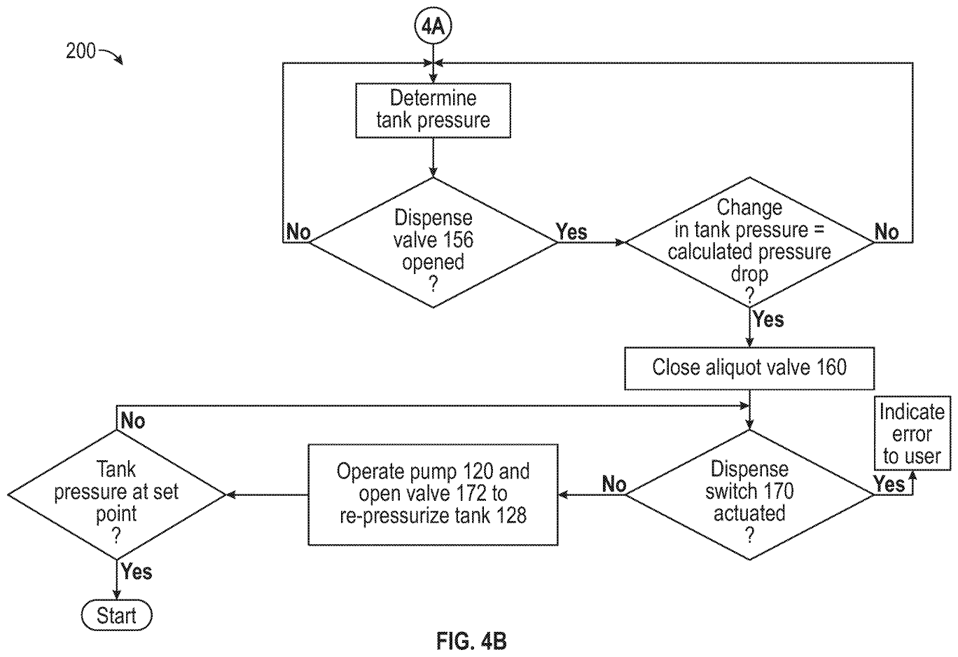

With reference to FIG. 5, Vₚ refers to the total volume of the pipette (e.g., pipette 110). Aₚ refers to the area of the cross-section of the pipette. Pᵢ refers to the initial pressure. Vᵢ refers to the initial volume of fluid within pipette. P_{d} refers to the injected pressure. V_{d} refers to the injected volume. P_{f} refers to final pressure. V_{f} refers to final volume of fluid within pipette 110. The term hᵢ refers to the initial height of the fluid column within pipette 110. The term h_{f} refers to the final height of the fluid column within pipette 110. Pₐₜₘ refers to atmospheric pressure.

Assume T is constant, injecting n number of air molecules is equivalent to injecting a known volume at a known pressure.

P_{d}V_{d}=nRT (1)

Total volume of the pipette remains constant.

Vₚ=Vᵢ+hᵢAₚ=V_{f}+h_{f}Aₚ (2)

Final amount of air in pipette is equal to initial plus injected. Again assuming that T is constant.

P_{f}V_{f}=PᵢVᵢ+P_{d}V_{d} (3)

Pressure in pipette settles out to be atmospheric minus the weight of the water column.

Pᵢ=Pₐₜₘ−μghᵢ (4)

P_{f}=Pₐₜₘ−μgh_{f} (5)

Solve equation (2) for Vs.

V_{f}=Vᵢ+hᵢAₚ−h_{f}Aₚ (6)

Substitute P_{f} and Pᵢ from equations (4) and (5) into equation (3).

(Pₐₜₘ−μgh_{f})V_{f}=(Pₐₜₘ−μghᵢ)Vᵢ+P_{d}V_{d} (7)

Substitute for V_{f} from equation (6) into equation (7).

(Pₐₜₘ−μgh_{f})(Vᵢ+hᵢAₚ−h_{f}Aₚ)=(Pₐₜₘ−μghᵢ)Vᵢ+P_{d}V_{d} (8)

PₐₜₘVᵢ+PₐₜₘhᵢAₚ−Pₐₜₘh_{f}Aₚ−μgh_{f}Vᵢ−μgh_{f}hᵢAₚ+μgh_{f}²Aₚ=PₐₜₘVᵢ−μghᵢVᵢ+P_{d}V_{d} (9)

Multiply through, solve for zero, factor out h_{f}.

PₐₜₘhᵢAₚ−Pₐₜₘh_{f}Aₚ−μgh_{f}Vᵢ−μgh_{f}hᵢAₚ+μgh_{f}²Aₚ+ρghᵢVᵢ−P_{d}V_{d}=0 (10)

(μgAₚ)h_{f}²−(PₐₜₘAₚ+μgVᵢ+ρghᵢAₚ)h_{f}+(ρghᵢVᵢ−P_{d}V_{d}+PₐₜₘhᵢAₚ)=0 (11)

Plug in coefficients from equation (11) into quadratic formula to solve for h_{f} (the root where the radical is subtracted is the only one that gives a real answer).

$${h}_{f} = \frac{\begin{matrix}( {P}_{atm} {A}_{p} + ρ {gV}_{i} + ρ {gh}_{i} {A}_{p} ) - \\ \sqrt{{( {P}_{atm} {A}_{p} + ρ {gV}_{i} + ρ {gh}_{i} {A}_{p} )}^{2} - 4 ( ρ {gA}_{p} ) ( ρ {gh}_{i} {V}_{i} - {P}_{d} {V}_{d} + {P}_{atm} {h}_{i} {A}_{p} )}\end{matrix}}{2 ( ρ {gA}_{p} )} \qquad ( 12 )$$

Volume of water dispensed V_{AQ} is equal to change in water column height times pipette cross-sectional area.

V_{AQ}=(hᵢ−h_{f})Aₚ (13)

Define ΔP_{N} as gauge pressure in nozzle (above the surface of the liquid) before the dispense.

ΔP_{N}=Pᵢ−Pₐₜₘ (14)

Solve equations (4) and (5) for hᵢ and h_{f} and substitute in equation (14).

$${h}_{i} = ( \frac{{P}_{atm} - {P}_{i}}{ρ g} ) = \frac{- Δ {P}_{N}}{ρ g} \qquad ( 15 )$$

$${h}_{f} = ( \frac{{P}_{atm} - {P}_{i}}{ρ g} ) - \frac{{V}_{AQ}}{{A}_{P}} = \frac{- Δ {P}_{N}}{ρ g} - \frac{{V}_{AQ}}{{A}_{P}} \qquad ( 16 )$$

Solve equation (10) for P_{d}V_{d}.

P_{d}V_{d}=PₐₜₘhᵢAₚ−Pₐₜₘh_{f}Aₚ−ρgh_{f}Vᵢ−ρgh_{f}hᵢAₚ+ρgh_{f}Aₚ+ρghᵢVᵢ (17)

Substitute equations (15) and (16) into equation (17).

$${P}_{d} {V}_{d} = {P}_{atm} \frac{- Δ {P}_{N}}{ρ g} {A}_{p} - {P}_{atm} ( \frac{- Δ {P}_{N}}{ρ g} - \frac{{V}_{AQ}}{{A}_{P}} ) {A}_{p} - ρ g ( \frac{- Δ {P}_{N}}{ρ g} - \frac{{V}_{AQ}}{{A}_{P}} ) {V}_{i} - ρ g ( \frac{- Δ {P}_{N}}{ρ g} - \frac{{V}_{AQ}}{{A}_{P}} ) \frac{- Δ {P}_{N}}{ρ g} {A}_{p} + ρ g {( \frac{- Δ {P}_{N}}{ρ g} - \frac{{V}_{AQ}}{{A}_{P}} )}^{2} {A}_{p} + ρ g \frac{- Δ {P}_{N}}{ρ g} {V}_{i} \qquad ( 18 )$$

$${P}_{d} {V}_{d} = {P}_{atm} \frac{Δ {P}_{N}}{ρ g} {A}_{p} - {P}_{atm} \frac{Δ {P}_{N}}{ρ g} {A}_{p} + {P}_{atm} \frac{{V}_{AQ}}{{A}_{P}} {A}_{p} + ρ g \frac{Δ {P}_{N}}{ρ g} {V}_{i} + ρ g \frac{{V}_{AQ}}{{A}_{P}} {V}_{i} - \frac{Δ {P}_{N}}{ρ g} Δ {P}_{N} {A}_{p} - \frac{{V}_{AQ}}{{A}_{P}} Δ {P}_{N} {A}_{p} + ρ g {( \frac{- Δ {P}_{N}}{ρ g} )}^{2} {A}_{p} + 2 ρ g \frac{Δ {P}_{N}}{ρ g} \frac{{V}_{AQ}}{{A}_{P}} {A}_{p} + ρ g {( \frac{{V}_{AQ}}{{A}_{P}} )}^{2} {A}_{p} - Δ {P}_{N} {V}_{i} \qquad ( 19 )$$

$${P}_{d} {V}_{d} = {P}_{atm} {V}_{AQ} + Δ {P}_{N} {V}_{i} + ρ g \frac{{V}_{AQ}}{{A}_{P}} {V}_{i} - \frac{Δ {P}_{N}^{2}}{ρ g} {A}_{p} - {V}_{AQ} Δ {P}_{N} + \frac{Δ {P}_{N}^{2}}{ρ g} {A}_{p} + 2 Δ {P}_{N} {V}_{AQ} + ρ g \frac{{V}_{AQ}^{2}}{{A}_{P}} - Δ {P}_{N} {V}_{i} \qquad ( 20 )$$

Multiply through, and simplify a few times.

$${P}_{d} {V}_{d} = {P}_{atm} {V}_{AQ} + ρ g \frac{{V}_{AQ}}{{A}_{P}} {V}_{i} + Δ {P}_{N} {V}_{AQ} + ρ g \frac{{V}_{AQ}^{2}}{{A}_{P}} \qquad ( 21 )$$

Solve equation (2) for Vᵢ and substitute in equation (15).

$${V}_{i} = {V}_{p} - {h}_{i} {A}_{p} = {V}_{p} + \frac{Δ {P}_{N}}{ρ g} {A}_{p} \qquad ( 22 )$$

Substitute equation (22) into equation (21).

$${P}_{d} {V}_{d} = {P}_{atm} {V}_{AQ} + ρ g \frac{{V}_{AQ}}{{A}_{P}} ( {V}_{p} + \frac{Δ {P}_{N}}{ρ g} {A}_{p} ) + Δ {P}_{N} {V}_{AQ} + ρ g \frac{{V}_{AQ}^{2}}{{A}_{P}} \qquad ( 23 )$$

Multiply through and simplify.

$${P}_{d} {V}_{d} = {P}_{atm} {V}_{AQ} + ρ g \frac{{V}_{AQ}}{{A}_{P}} {V}_{p} + ρ g \frac{{V}_{AQ}}{{A}_{P}} \frac{Δ {P}_{N}}{ρ g} {A}_{p} + Δ {P}_{N} {V}_{AQ} + ρ g \frac{{V}_{AQ}^{2}}{{A}_{P}} \qquad ( 24 )$$

$${P}_{d} {V}_{d} = {P}_{atm} {V}_{AQ} + ρ g \frac{{V}_{AQ}}{{A}_{P}} {V}_{p} + 2 Δ {P}_{N} {V}_{AQ} + ρ g \frac{{V}_{AQ}^{2}}{{A}_{P}} \qquad ( 25 )$$

Factor out desired dispense volume.

$${P}_{d} {V}_{d} = {V}_{AQ} ( {P}_{atm} + ρ g \frac{{V}_{p}}{{A}_{P}} + 2 Δ {P}_{N} + ρ g \frac{{V}_{AQ}}{{A}_{P}} ) \qquad ( 26 )$$

Simplify.

$${P}_{d} {V}_{d} = {V}_{AQ} ( {P}_{atm} + 2 Δ {P}_{N} + ρ g \frac{( {V}_{p} + {V}_{AQ} )}{{A}_{P}} ) \qquad ( 27 )$$

Solve equation (26) for P_{d}.

$${P}_{d} = \frac{{V}_{AQ}}{{V}_{d}} ( {P}_{atm} + 2 Δ {P}_{N} + ρ g \frac{( {V}_{p} + {V}_{AQ} )}{{A}_{P}} ) \qquad ( 28 )$$

When V_{d} is taken to be the volume of the pressure tank, P_{d} would be the required drop in the pressure tank pressure to dispense V_{AQ} of liquid given assumptions about the cross-sectional area (Aₚ) and the volume (Vₚ) of the pipettes and going off of the nozzle gauge pressure (ΔP_{N}), also assuming water density, and generally isothermal conditions, and an entirely cylindrical pipette. (Vₚ should include the dead volume inside the controller air path, so replace Vₚ with Vₚ+V_{dv}.)

$${P}_{d} = \frac{{V}_{AQ}}{{V}_{d}} ( {P}_{atm} + 2 Δ {P}_{N} + ρ g \frac{( {V}_{p} + {V}_{dv} {V}_{AQ} )}{{A}_{P}} ) \qquad ( 29 )$$

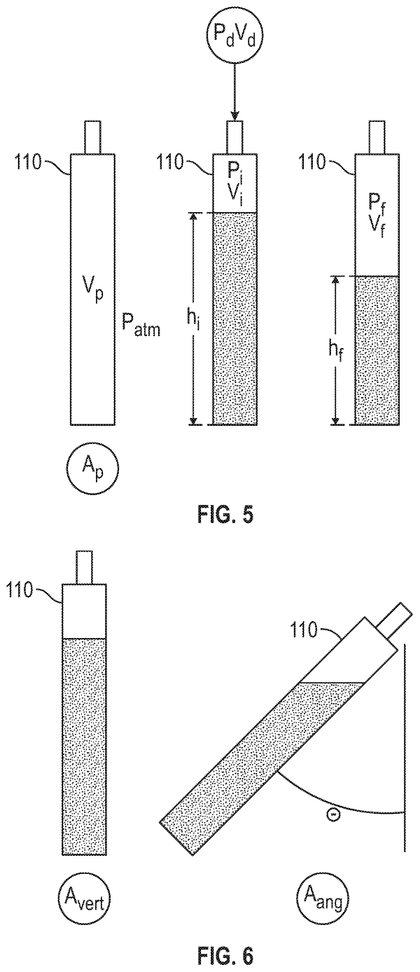

Referring to FIG. 6, according to embodiments, an orientation of a pipette may be determined. For example, the orientation of pipette 110 may be determined by the electronic controller 122 using the orientation sensor 184 (FIG. 3). In the event that the pipette is held at an angle Θ instead of vertically, the volume terms in equation (29) will remain the same since volume is independent of orientation. The Aₚ term is, however, affected, since the area of the water in the pipette that the air pressure now has an effect on is a larger oval rather than the original circle that is present when the pipette is held vertically.

$${A}_{ang} = \frac{{A}_{vert}}{cos ( θ )} \qquad ( 30 )$$

One way to solve for the change in the Aₚ term is to take advantage of the fact that the volume of water is independent of Θ.

V_{w}=Aᵥₑᵣₜh_{WCvert}=A_{ang}h_{WCang}=A_{ang}(h_{WCvert} cos(Θ) (31)

The product of the area of the pipette when the pipette is vertical and the height of the water column when the pipette is vertical (h_{WCvert}) is equal to the product of the area of the pipette when the pipette is angled and the height of the water column when the pipette is angled (h_{WCang}). Given the geometry of the arrangement, the height of the water column when it is angled is cos (Θ) times the height of the vertical water column, so solving for the area of the angled pipette results in equation (30).

Substituting this definition of the area of the pipette that accounts for the angle back into equation (29) provides:

$${P}_{d} = \frac{{V}_{AQ}}{{V}_{d}} ( {P}_{atm} + 2 Δ {P}_{N} + ρ g \frac{( {V}_{p} + {V}_{dv} {V}_{AQ} )}{\frac{{A}_{P}}{cos ( θ )}} ) \qquad ( 32 )$$

Based on the derivation above, the electronic controller 122 uses this equation to compute the pressure drop P_{d} required to achieve the set aliquot volume V_{AQ}. Note that the dead volume Vav in the pipette controller is small relative to the serological pipette volume Vₚ, and that the set aliquot volume V_{AQ} is also usually small relative to Vₚ. Therefore, the term (Vₚ+V_{dv}+V_{AQ})/Aₚ is approximately equal to Vₚ/Aₚ. This is the length of the serological pipette, and since most serological pipettes are about the same length, this term is relatively constant and can be ignored to a first order effect. Alternatively, −Vₚ, V_{dv} and Aₚ could be entered via a keypad or other data entry method.

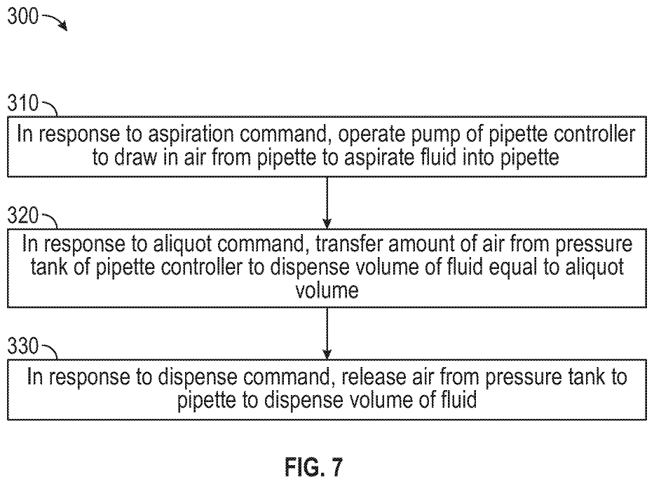

FIG. 7 is a flowchart showing a method 300 of aspirating and dispensing a fluid from a pipette using a pipette controller. While reference is made to the pipette controller 100 of FIGS. 1 to 3, the method 300 can be utilized with any type of apparatus that aspirates and dispenses a fluid.

As shown in FIG. 7, the method 300 includes, in step 310, in response to an aspiration command, operating a pump of the pipette controller to draw in air from the pipette to aspirate fluid into the pipette. For example, with reference to the pipette controller 100 illustrated in FIGS. 1 to 3, step 310 can include, in response to receiving the aspiration command signal from the aspiration switch 164 (e.g., via actuation of the aspiration actuation 112), the electronic controller 122 moves the pump valve 172 from the first position to the second position, which permits airflow between the pump conduit 138 and the air vent 174, and then operates the pump 120, which, being in communication with the air vent 174 via the pump valve 172, causes the pump 120 to draw in air from the nozzle assembly 108 along the pipette conduit 142 to the aspiration conduit 140.

The method 300 further includes, in step 320, in response to an aliquot command, transferring an amount of air from a pressure tank of the pipette controller to dispense a volume of fluid equal to an aliquot volume. For example, with reference again to the pipette controller 100 illustrated in FIGS. 1 to 3, step 320 can include, in response to receiving the aliquot command signal from the dispense switch 170 (e.g., via actuation of the dispense actuator 114 while the pipette controller 100 is in the aliquot mode), the electronic controller 122 leaves the pump valve 172 in the first position, which permits airflow from the air vent 174 to the pump conduit 138, and operates the pump 120 to inject air (e.g., atmospheric air from the air vent 174) along the pump conduit 138 to pressurize the pressure tank 128 to a predetermined target tank pressure. Once the predetermined target tank pressure is achieved within the pressure tank 128 (e.g., as sensed by the pressure tank sensor 180), the electronic controller 122 releases the aliquot valve 160 from the closed position to the normally open position, which permits positive air pressure from the pressure tank 128 to the nozzle assembly 108 and thus dispensing an aliquot volume of fluid contained within the pipette 110.

Referring still to FIG. 7, the method 300 further includes, in step 330, in response to a dispense command, releasing air from the pressure tank to the pipette to dispense a volume of fluid from the pipette. For example, with reference again to the pipette controller 100 illustrated in FIGS. 1 to 3, step 330 can include, in response to receiving the dispense command signal from the dispense switch 170 (e.g., via actuation of the dispense actuator 114), the electronic controller 122 leaves the pump valve 172 in the first position, which permits airflow from the air vent 174 to the pump conduit 138, and operates the pump 120 to inject air (e.g., atmospheric air from the air vent 174) into the pressure tank 128 to maintain air flow through the pressure tank 128 to the aliquot valve 160 and then through the dispense valve 156 to the nozzle assembly 108. Thus, a dispense of fluid is released from the pipette 110 as the dispense valve 156 is moved from the closed position toward the open position (e.g., via actuation of the dispense actuator 114 by the user).

In some embodiments, step 330 can be performed before step 320. In some embodiments, method 300 may not include step 320 or step 330. In some embodiments, method 300 may include one or more additional steps before step 320 or before step 330. For example, in some such embodiments, from an aspiration mode (e.g., as in step 310), a user can select an aliquot mode or a dispense mode of the pipette controller before step 320 or step 330, respectively.

Accordingly, the present disclosure provides for a pipette controller that can provide for accurate dispensing of aliquots of liquid via a single dispense actuator. Thus, embodiments of the present disclosure can provide a pipette controller that accurately dispenses aliquots of liquid, but with a significantly less complex system structure, thus, providing a reduced overall size and weight, as compared to conventional pipette controllers.

Further aspects of the present disclosure are provided by the subject matter of the following clauses.

A pipette controller includes a nozzle assembly configured to operatively connect a pipette to the pipette controller, a pressure tank pneumatically connected to the nozzle assembly, a pump pneumatically connected to the nozzle assembly and to the pressure tank, an aliquot valve, an aspiration valve, and an electronic controller in electrical communication with the pump, the aliquot valve, and the aspiration valve. The electronic controller is configured, in response to receiving an aspiration command signal, to operate the pipette controller in an aspiration mode by operating the pump to draw in air from the nozzle assembly, and, in response to receiving an aliquot command signal, to operate the pipette controller in an aliquot mode by transferring an amount of air from the pressure tank to the nozzle assembly to dispense a volume of fluid from the pipette equal to an aliquot volume.

The pipette controller of the preceding clause, further including an aliquot volume control interface in electrical communication with the electronic controller, the aliquot volume control interface being operable to set the aliquot volume.

The pipette controller of any preceding clause, further including a dispense valve, a dispense actuator operable by a user to move the dispense valve from a closed position toward an open position, and an aspiration actuator operable by the user to move the aspiration valve from a closed position toward an open position.

The pipette controller of any preceding clause, further including a dispense switch and an aspiration switch. The dispense switch being in electrical communication with the electronic controller and arranged to detect actuation of the dispense actuator and to provide the aliquot command signal to the electronic controller when the pipette controller is operated in the aliquot mode. The aspiration switch being in electrical communication with the electronic controller and arranged to detect actuation of the aspiration actuator and to provide the aspiration command signal to the electronic controller when the pipette controller is operated in the aspiration mode.

The pipette controller of any preceding clause, further including a pressure tank sensor in electrical communication with the electronic controller and arranged to sense the tank air pressure within the pressure tank. The electronic controller being further configured to determine, based on signals received from the pressure tank sensor, when the tank air pressure reaches a predetermined air pressure corresponding to the amount of air transferred from the pressure tank to the nozzle assembly to dispense the volume of fluid equal to the aliquot volume.

The pipette controller of any preceding clause, with the pipette controller operating in the aliquot mode, the electronic controller is further configured, after the aliquot volume is dispensed, to operate the pump to reinject air into the pressure tank to a predetermined target tank air pressure corresponding to the aliquot volume.

The pipette controller of any preceding clause, further including a dispense valve that is arranged such that, when the dispense valve is moved toward an open position, positive air pressure from the pressure tank flows through the aliquot valve and the dispense valve to the nozzle assembly.

The pipette controller of any preceding clause, the aliquot valve being a normally open solenoid actuated ball valve.

The pipette controller of any preceding clause, the pressure tank being pneumatically connected to a pipette conduit of the nozzle assembly via a dispense conduit extending from the pressure tank to the pipette conduit, the aliquot valve and the dispense valve being arranged along the dispense conduit.

The pipette controller of any preceding clause, the dispense valve being arranged along the dispense conduit between the aliquot valve and the pipette conduit.

The pipette controller of any preceding clause, further including a dispense actuator operable by a user to move the dispense valve from a closed position toward the open position. The aliquot command signal being provided to the electronic controller when the dispense actuator is actuated by the user, while the pipette controller is operated in the aliquot mode.

The pipette controller of any preceding clause, the electronic controller being further configured to operate the pipette controller in a dispense mode and, in response to receiving a dispense command signal, to release air from the pressure tank to the nozzle assembly to dispense the volume of fluid from the pipette, while the dispense actuator is actuated by the user. The dispense command signal is provided to the electronic controller when the dispense actuator is actuated by the user while the pipette controller is operated in the dispense mode.

The pipette controller of any preceding clause, the pump being pneumatically connected to the nozzle assembly via an aspiration conduit extending from a pump inlet to a pipette conduit and to the pressure tank via a pump conduit extending from a pump outlet to the nozzle assembly, the aspiration valve being arranged along the aspiration conduit.

The pipette controller of any preceding clause, further including a pump valve pneumatically connecting the pump conduit and the aspiration conduit to an air vent via a vent conduit, the pump valve being selectively movable between a first position, in which airflow is permitted between the pump conduit and atmosphere via the air vent, and a second position, in which airflow is permitted between the aspiration conduit and the atmosphere via the air vent.

The pipette controller of any preceding clause, in response to receiving the aspiration command signal while the pipette controller is operated in the aspiration mode, the electronic controller is further configured to move the pump valve to the first position.

The pipette controller of any preceding clause, in response to receiving the aliquot command signal while the pipette controller is operated in the aliquot mode, the electronic controller is further configured to move the pump valve to the second position.

The pipette controller of any preceding clause, while the pipette controller is operated in the aliquot mode, the electronic controller is further configured to move the pump valve from the second position to the first position, when the amount of air from the pressure tank is transferred to the nozzle assembly to dispense the volume of fluid equal to the aliquot volume.

A pipette controller includes a nozzle assembly including a pipette conduit and configured to operatively connect a pipette to the pipette controller, a pressure tank pneumatically connected to the pipette conduit via a dispense conduit extending from the pressure tank to the pipette conduit, a pump pneumatically connected to the nozzle assembly via an aspiration conduit extending from a pump inlet to the pipette conduit and to the pressure tank, via a pump conduit extending from a pump outlet to the pressure tank, the pump being configured to inject air into the pressure tank along the pump conduit to create positive air pressure inside the pressure tank, an aliquot valve arranged along the dispense conduit, a dispense valve arranged along the dispense conduit, a dispense actuator operable by a user to move the dispense valve from a closed position toward a fully open position, an aspiration valve arranged along the aspiration conduit, an aspiration actuator operable by the user to move the aspiration valve from a closed position toward an open position, and an electronic controller in electrical communication with the pump, the aliquot valve, the dispense valve, and the aspiration actuator. The electronic controller is configured, in response to receiving an aspiration command signal from the aspiration actuator, to operate the pipette controller in an aspiration mode by operating the pump to draw in air from the nozzle assembly.

The pipette controller of the preceding clause, further including a pump valve pneumatically connected to the pump conduit, the aspiration conduit, and an air vent via a vent conduit, the pump valve being selectively movable between a first position, in which airflow is permitted between the pump conduit and atmosphere via the air vent, and a second position, in which airflow is permitted between the aspiration conduit and atmosphere via the air vent.

The pipette controller of any preceding clause, the electronic controller being in electrical communication with the pump and the pump valve, the electronic controller being further configured, in response to receiving the aspiration command signal, to move the pump valve to the second position to operate the pump to draw in air from the nozzle assembly along the pipette conduit to the aspiration conduit.

The pipette controller of any preceding clause, the aspiration actuator is configured such that the aspiration valve is movable, via the aspiration actuator, to one of a plurality of partially open positions between the closed position and the fully open position to vary flow of the positive air pressure through the aspiration valve.

The pipette controller of the preceding clause, further including an atmospheric pressure sensor to measure atmospheric pressure at the air vent.

The pipette controller of the preceding clause, the dispense valve being arranged along the dispense conduit between the aliquot valve and the nozzle assembly, and the aliquot valve is a normally open solenoid actuated ball valve.

The pipette controller of the preceding clause, the dispense valve being arranged along the dispense conduit between the aliquot valve and the pipette conduit.

The pipette controller of the preceding clause, the aliquot valve being a normally open solenoid actuated ball valve.

The pipette controller of the preceding clause, the electronic controller being further configured to keep the aliquot valve in the closed position until a dispense command signal is received from the dispense actuator.

The pipette controller of the preceding clause, the electronic controller being further configured, in response to receiving the dispense command signal, to release the aliquot valve from the closed position to the open position such that positive air pressure provided from the pressure tank flows through the aliquot valve and then through the dispense valve to the nozzle assembly.

The pipette controller of the preceding clause, the dispense actuator being configured such that the dispense valve is movable, via the dispense actuator, to one of a plurality of partially open positions between the closed position and the fully open position to vary flow of the positive air pressure through the dispense valve.

The pipette controller of the preceding clause, the dispense actuator being configured such that the aliquot valve is released from the closed position to the open position, via the electronic controller, before the dispense valve is moved by the user from the closed position toward the fully open position.

The pipette controller of the preceding clause, further including a pressure tank sensor arranged to sense a tank air pressure within the pressure tank. The electronic controller being further configured to determine, based on signals received from the pressure tank sensor, when the tank air pressure reaches a predetermined tank air pressure corresponding to an amount of air transferred from the pressure tank to the nozzle assembly to dispense a volume of fluid equal to an aliquot volume, and to move the aliquot valve from the open position to the closed position when the tank air pressure reaches the predetermined tank air pressure.

The pipette controller of the preceding clause, further including an aliquot volume control interface in electrical communication with the electronic controller, the aliquot volume control interface being operable by the user to set the aliquot volume.

The pipette controller of the preceding clause, the electronic controller being further configured, when the tank air pressure reaches the predetermined tank air pressure, to operate the pump to reinject air into the pressure tank along the pump conduit to a predetermined target tank air pressure corresponding to the set aliquot volume.

The pipette controller of the preceding clause, the dispense actuator being configured such that the dispense valve is movable, via the dispense actuator, to one of a plurality of partially open positions between the closed position and the fully open position to vary a dispense speed of the aliquot volume.

The pipette controller of the preceding clause, further including a pipette sensor arranged to sense a pipette air pressure at the nozzle assembly.

The pipette controller of the preceding clause, the aliquot volume control interface including a display screen, and the electronic controller is further configured to control the display screen to display the set aliquot volume.

The pipette controller of the preceding clause, further including an orientation sensor in electrical communication with the electronic controller and configured, when the pipette is coupled to the nozzle assembly, to sense an angle of the pipette relative to a reference axis. The electronic controller being further configured to determine, based on signals received from the orientation sensor, the angle of the pipette, and to adjust, based on the determined angle of the pipette, the amount of air transferred from the pressure tank to the nozzle assembly to dispense the volume of fluid equal to the set aliquot volume.

A method of aspirating and dispensing a fluid from a pipette using a pipette controller includes operating the pipette controller in an aspiration mode and, in response to an aspiration command, operating a pump of the pipette controller to draw in air from the pipette to aspirate the fluid into the pipette, and operating the pipette controller in an aliquot mode and, in response to an aliquot command, transferring an amount of air from a pressure tank of the pipette controller to the pipette to dispense a volume of the fluid equal to an aliquot volume.

The method of the preceding clause, the aliquot volume of fluid to be dispensed from the pipette being selectable via an aliquot volume control interface of the pipette controller.

The method of any preceding clause, further including, in response to the aliquot command while the pipette controller is operated in the aliquot mode, determining, via a tank pressure sensor, when the tank air pressure reaches a predetermined tank air pressure corresponding to the amount of air transferred from the pressure tank to the pipette to dispense the volume of the fluid equal to the aliquot volume.

The method of any preceding clause, further including, when the tank air pressure reaches the predetermined tank air pressure, moving an aliquot valve of the pipette controller from a normally open position to a closed position.

The method of any preceding clause, in response to the aspiration command while the pipette controller is operated in the aspiration mode, an aliquot valve of the pipette controller is moved from a normally open position to a closed position.

The method of any preceding clause, in response to the aliquot command while the pipette controller is operated in the aliquot mode, the aliquot valve being released from the closed position to the normally open position such that, when a dispense valve of the pipette controller downstream of the aliquot valve is opened, positive air pressure from the pressure tank flows through the aliquot valve and then through the dispense valve to the pipette.

The method of any preceding clause, the aspiration command being provided when an aspiration valve of the pipette controller is moved from a closed position toward an open position while the pipette controller is operated in the aspiration mode.

The method of any preceding clause, the aliquot command being provided when a dispense valve of the pipette controller is moved from a closed position toward an open position while the pipette controller is operated in the aliquot mode.

The method of any preceding clause, the aliquot command being provided when a user engages a dispense actuator of the pipette controller, the dispense actuator being operable by the user to move the dispense valve from the closed position toward the open position.

The method of any preceding clause, the dispense speed of the aliquot volume can be varied by a user via the dispense actuator.

The method of any preceding clause, further including operating the pipette controller in a dispense mode and, in response to a dispense command, releasing air from the pressure tank to a nozzle assembly to dispense a volume of fluid while the dispense valve is moved toward the open position.

The method of any preceding clause, the dispense command being provided when the dispense valve is moved from the closed position toward the open position while the pipette controller is operated in the dispense mode.

Although the foregoing description is directed to some embodiments of the present disclosure, other variations and modifications will be apparent to those skilled in the art and may be made without departing from spirit and scope of the present disclosure. Moreover, features described in connection with one embodiment of the present disclosure may be used in conjunction with other embodiments, even if not explicitly stated above.

1. A pipette controller comprising:
a nozzle assembly configured to operatively connect a pipette to the pipette controller;
a pressure tank pneumatically connected to the nozzle assembly;
a pump pneumatically connected to the nozzle assembly and to the pressure tank;
an aliquot valve;
an aspiration valve; and
an electronic controller in electrical communication with the pump, the aliquot valve, and the aspiration valve, the electronic controller being configured:
in response to receiving an aspiration command signal, to operate the pipette controller in an aspiration mode by operating the pump to draw in air from the nozzle assembly; and
in response to receiving an aliquot command signal, to operate the pipette controller in an aliquot mode by transferring an amount of air from the pressure tank to the nozzle assembly to dispense a volume of fluid from the pipette equal to an aliquot volume.

2. The pipette controller of claim 1, further comprising:
a dispense valve;
a dispense actuator operable by a user to move the dispense valve from a closed position toward an open position; and
an aspiration actuator operable by the user to move the aspiration valve from a closed position toward an open position.

3. The pipette controller of claim 2, further comprising:
a dispense switch in electrical communication with the electronic controller, the dispense switch being arranged to detect actuation of the dispense actuator and to provide the aliquot command signal to the electronic controller when the pipette controller is operated in the aliquot mode; and
an aspiration switch in electrical communication with the electronic controller, the aspiration switch being arranged to detect actuation of the aspiration actuator and to provide the aspiration command signal to the electronic controller when the pipette controller is operated in the aspiration mode.

4. The pipette controller of claim 1, further comprising a pressure tank sensor in electrical communication with the electronic controller and arranged to sense the tank air pressure within the pressure tank,
wherein the electronic controller is further configured to determine, based on signals received from the pressure tank sensor, when the tank air pressure reaches a predetermined air pressure corresponding to the amount of air transferred from the pressure tank to the nozzle assembly to dispense the volume of fluid equal to the aliquot volume.

5. The pipette controller of claim 4, wherein, with the pipette controller operating in the aliquot mode, the electronic controller is further configured, after the aliquot volume is dispensed, to operate the pump to reinject air into the pressure tank to a predetermined target tank air pressure corresponding to the aliquot volume.

6. The pipette controller of claim 1, further comprising a dispense valve that is arranged such that, when the dispense valve is moved toward an open position, positive air pressure from the pressure tank flows through the aliquot valve and the dispense valve to the nozzle assembly.

7. The pipette controller of claim 6, wherein the pressure tank is pneumatically connected to a pipette conduit of the nozzle assembly via a dispense conduit extending from the pressure tank to the pipette conduit, the aliquot valve and the dispense valve being arranged along the dispense conduit.

8. The pipette controller of claim 7, wherein the dispense valve is arranged along the dispense conduit between the aliquot valve and the pipette conduit.

9. The pipette controller of claim 6, further comprising a dispense actuator operable by a user to move the dispense valve from a closed position toward the open position, wherein the aliquot command signal is provided to the electronic controller when the dispense actuator is actuated by the user, while the pipette controller is operated in the aliquot mode.

10. The pipette controller of claim 9, wherein the electronic controller is further configured:
to operate the pipette controller in a dispense mode and, in response to receiving a dispense command signal, to release air from the pressure tank to the nozzle assembly to dispense the volume of fluid from the pipette, while the dispense actuator is actuated by the user,
wherein the dispense command signal is provided to the electronic controller when the dispense actuator is actuated by the user while the pipette controller is operated in the dispense mode.

11. The pipette controller of claim 1, wherein the pump is pneumatically connected to the nozzle assembly via an aspiration conduit extending from a pump inlet to a pipette conduit and to the pressure tank via a pump conduit extending from a pump outlet to the nozzle assembly, the aspiration valve being arranged along the aspiration conduit.

12. The pipette controller of claim 11, further comprising a pump valve pneumatically connecting the pump conduit and the aspiration conduit to an air vent via a vent conduit, the pump valve being selectively movable between a first position, in which airflow is permitted between the pump conduit and atmosphere via the air vent, and a second position, in which airflow is permitted between the aspiration conduit and the atmosphere via the air vent.

13. The pipette controller of claim 12, wherein, in response to receiving the aspiration command signal while the pipette controller is operated in the aspiration mode, the electronic controller is further configured to move the pump valve to the first position.

14. The pipette controller of claim 13, wherein, in response to receiving the aliquot command signal while the pipette controller is operated in the aliquot mode, the electronic controller is further configured to move the pump valve to the second position.

15. The pipette controller of claim 14, wherein, while the pipette controller is operated in the aliquot mode, the electronic controller is further configured to move the pump valve from the second position to the first position, when the amount of air from the pressure tank is transferred to the nozzle assembly to dispense the volume of fluid equal to the aliquot volume.

16. A method of aspirating and dispensing a fluid from a pipette using a pipette controller, the method comprising:
operating the pipette controller in an aspiration mode and, in response to an aspiration command, operating a pump of the pipette controller to draw in air from the pipette to aspirate the fluid into the pipette; and
operating the pipette controller in an aliquot mode and, in response to an aliquot command, transferring an amount of air from a pressure tank of the pipette controller to the pipette to dispense a volume of the fluid equal to an aliquot volume.

17. The method of claim 16, further comprising:
in response to the aliquot command while the pipette controller is operated in the aliquot mode, determining, via a tank pressure sensor, when the tank air pressure reaches a predetermined tank air pressure corresponding to the amount of air transferred from the pressure tank to the pipette to dispense the volume of the fluid equal to the aliquot volume; and
when the tank air pressure reaches the predetermined tank air pressure, moving an aliquot valve of the pipette controller from a normally open position to a closed position.

18. The method of claim 16, wherein, in response to the aspiration command while the pipette controller is operated in the aspiration mode, an aliquot valve of the pipette controller is moved from a normally open position to a closed position.

19. The method of claim 18, wherein, in response to the aliquot command while the pipette controller is operated in the aliquot mode, the aliquot valve is released from the closed position to the normally open position such that, when a dispense valve of the pipette controller downstream of the aliquot valve is opened, positive air pressure from the pressure tank flows through the aliquot valve and then through the dispense valve to the pipette.

20. The method of claim 16, wherein the aspiration command is provided when an aspiration valve of the pipette controller is moved from a closed position toward an open position while the pipette controller is operated in the aspiration mode, and
wherein the aliquot command is provided when a dispense valve of the pipette controller is moved from a closed position toward an open position while the pipette controller is operated in the aliquot mode.
